(19) United States
(12) Patent Application Publication
(10) Pub. No.: US 2018/0196609 A1
(43) Pub. Date: Jul. 12, 2018

(54) Data Deduplication Using Multi-Chunk Predictive Encoding

(71) Applicant: QUALCOMM Incorporated, San Diego, CA (US)

(72) Inventor: Urs Niesen, Summit, NJ (US)

(21) Appl. No.: 15/603,669

(22) Filed: May 24, 2017

Related U.S. Application Data
(60) Provisional application No. 62/445,498, filed on Jan. 12, 2017.

(51) Int. Cl. G06F 3/06

(52) U.S. Cl. CPC G06F 3/0608; G06F 3/067; G06F 3/0659; G06F 3/0638

(57) ABSTRACT

Various embodiments may include methods, devices, and non-transitory processor-readable media for performing data stream encoding by identifying a first data chunk and calculating a first hash value for the first data chunk. A device may determine whether the calculated first hash value is located within a hash table. If so, then the computing device may encode the first data chunk as the first hash value, but if the hash value is not stored in the hash table, a new entry for the hash value may be added to the hash table. A second data chunk may be identified and a hash value calculated. The device compares the second hash value to a next value stored in the hash table. If the second hash value matches the next hash value, the device encodes the second data chunk as a flag indicating that a predicted pattern of data chunks is being followed.

### RELATED APPLICATIONS

This application claims the benefit of priority U.S. Provisional Application No. 62/445,498 entitled “Data Deduplication Using Multi-Chunk Predictive Encoding” filed Jan. 12, 2017, the entire contents of which are hereby incorporated by reference.

### BACKGROUND

Data deduplication is a method for removing duplicate data chunks from data streams. It is widely used in cloud computing and enterprise server environments. For example, an email with an attachment that is sent to 10 people in an organization does not need to be stored 10 times. Using deduplication, the email server detects the duplication in the 10 people's inboxes and stores the attachment only once instead of 10 times. Also, a cloud computing server storing two virtual machine (VM) disk images of different versions of the same operating system can seamlessly detect any overlap of parts of these VM disk images and store duplicate parts only once.

### SUMMARY

Various embodiments include methods and computing devices implementing the methods for storing data a deduplicated format using a multi-chunk predictive encoding scheme in computing devices. Various embodiments may include a processor determining a first hash value for a first data chunk of a data stream or data file, encoding the first data chunk as the determined first hash value, determining whether the determined first hash value is located within a hash table stored in a memory of the computing device, and in response to determining that the determined first hash value is located within the hash table stored in the memory of the computing device: determining a second hash value for a second data chunk having a positional relationship to the first data chunk within the data stream or data file, determining whether the determined second hash value matches a first data chunk sequence value stored in the hash table in association with the first hash value, and encoding the second data chunk in an encoded sequence as a true indicator in response to determining that the determined second hash value matches the first data chunk sequence value.

Some embodiments may include assigning data delineated by one or more data markers within the data stream or data file as a data chunk. In such embodiments, assigning the data delineated by the one or more data markers within the data stream or data file as a data chunk may include assigning the data delineated by the one or more data markers and at least one data marker as a data chunk.

In some embodiments in response to determining that the determined first hash value is not located within the hash table stored in the memory of the computing device, the processor of a computing device may store the determined first hash value and a pointer to a location in memory of the first data chunk in association, in the hash table, determine a second hash value for a second data chunk having a positional relationship to the first data chunk within the data stream or data file, and store the determined second hash value in the hash table as a first data chunk sequence value associated with the first hash value.

In some embodiments, in response to determining that the determined second hash value does not match the first data chunk sequence value, the processor of the computing device may insert a false indicator at a current location in the encoded sequence and encode the second data chunk in the encoded sequence as the determined second hash value.

In some embodiments, the true indicator may be a numeral indicating an offset of a current data chunk from a next data chunk that has a determined hash value that does not match a sequence value stored in the hash table in association with the current data chunk.

In some embodiments, the positional relationship of the second data chunk to the first data chunk within the data stream or data file may be contiguous.

Various embodiments include methods and computing devices implementing the methods for generating a data structure during encoding a data stream in computing devices. Various embodiments may include determining, by a processor of a computing device, a first hash value for a first data chunk of a data stream or data file, determining whether the determined first hash value is located within a hash table stored in a memory of the computing device, and in response to determining that the determined first hash value is not located within the hash table stored in the memory of the computing device storing in the hash table, the determined first hash value and a pointer to a location in a memory of the first data chunk in association, determining a second hash value for a second data chunk having a positional relationship to the first data chunk within the data stream or data file, and storing the determined second hash value in the hash table as a first data chunk sequence value associated with the first hash value.

Some embodiments may include assigning data delineated by one or more data markers within the data stream or data file as a data chunk.

Various embodiments include methods and computing devices implementing the methods for encoding a data stream or data file in computing devices. Such embodiments may include a processor of a computing device determining a first hash value for a first data chunk of a data stream or data file, encoding the first data chunk in an encoded sequence as the determined first hash value, determining a second hash value for a second data chunk having a positional relationship to the first data chunk within the data stream or data file, determining whether the determined second hash value matches a first data chunk sequence value stored in a hash table in a memory of the computing device, encoding the second data chunk in the encoded sequence as a true indicator in response to determining that the determined second hash value matches the first data chunk sequence value, and in response to determining that the determined second hash value does not match the first data chunk sequence value: inserting a false indicator at a current location in the encoded sequence, and encoding the second data chunk in the encoded sequence as the determined second hash value.

Some embodiments may further include assigning data delineated by one or more data markers within the data stream or data file as a data chunk. In such embodiments, assigning the data delineated by the one or more data markers within the data stream or data file as a data chunk may include assigning the data delineated by the one or more data markers and at least one data marker as a data chunk.

In some embodiments, the true indicator may be a numeral indicating an offset of a current data chunk from a next data chunk that has a determined hash value that does not match a sequence value stored in the hash table in association with the current data chunk.

Various embodiments include methods and computing devices implementing the methods for decoding an encoded data stream or file in computing devices. Such embodiments may include a processor retrieving, from a hash table stored in a memory of a computing device, a first pointer to a memory location storing a first data chunk associated with a first hash value within an encoded sequence representing an original data stream or data file, retrieving the first data chunk from the memory location indicated by the first pointer, adding the first data chunk to a decoded data stream or data file, determining whether a next encoded value in the encoded sequence is a false indicator, in response to determining that the next encoded value is not a false indicator retrieving, from the hash table, a first data chunk sequence value, retrieving, from the hash table, a second pointer to a memory location storing a second data chunk associated with a second hash value that matches the first data chunk sequence value, retrieving the second data chunk from the memory location of the indicated by the second pointer, and adding the second data chunk to the decoded data stream or data file.

In some embodiments, in response to determining that the next encoded value is a false indicator, the processor may retrieve, from the hash table, a third pointer to a memory location storing a third data chunk associated with a third hash value within the encoded sequence, retrieve the third data chunk from the memory location indicated by the third pointer, and adding the third data chunk to the decoded data stream or data file.

Various embodiments include a computing device having a processor configured with processor-executable to perform operations of one or more of the embodiment methods summarized above. Various embodiments include a non-transitory processor-readable medium having stored thereon processor-executable software instructions to cause a processor of a computing device to perform operations of one or more of the embodiment methods summarized above.

### BRIEF DESCRIPTION OF THE DRAWINGS

The accompanying drawings, which are incorporated herein and constitute part of this specification, illustrate exemplary embodiments of the methods and devices. Together with the general description given above and the detailed description given below, the drawings serve to explain features of the methods and devices, and not to limit the disclosed embodiments.

FIG. 1 is a block diagram illustrating a computing device suitable for use with various embodiments.

FIG. 2 is a block diagram illustrating encoding of a data stream according to known methods.

FIG. 3 is a block diagram illustrating encoding of a data stream according to various embodiments.

FIG. 4 is a block diagram illustrating encoding of a data stream according to various embodiments.

FIG. 5 is a process flow diagram illustrating an embodiment method of data encoding using multi-chunk predictive encoding according to various embodiments.

FIG. 6 is a process flow diagram illustrating an embodiment method of generating data structures during multi-chunk predictive encoding according to various embodiments.

FIG. 7 is a process flow diagram illustrating an embodiment method of data encoding during multi-chunk predictive encoding according to various embodiments.

FIG. 8 is a process flow diagram illustrating an embodiment method of decoding data previously encoded using multi-chunk predictive encoding according to various embodiments.

### DETAILED DESCRIPTION

Various embodiments will be described in detail with reference to the accompanying drawings. Wherever possible the same reference numbers will be used throughout the drawings to refer to the same or like parts. References made to particular examples and implementations are for illustrative purposes, and are not intended to limit the scope of the claims.

The various embodiments provide methods, devices, and non-transitory processor-readable media for the efficient encoding of data using multi-chunk predictive encoding data deduplication. Data deduplication reduces the amount of data that must be stored by a server in order to service redundant data requests by client devices, however the identification of duplicate data can consume large amounts of processing and power resources. The methods and devices may provide efficient data deduplication that encodes data chunks based on patterns or sequences of data chunks rather than individual data chunks. Thus, the methods accommodate data sequences containing both large and small chunks. The chunks only need to be stored once (through the next-chunk pointer in the hash table). When replicating sequences of chunks (e.g., chunk a followed by chunk b appears at least twice) appear, the data is highly compressed into a single hash followed by a sequence of single bit indicators (e.g., l's). This enables chunk lengths to be short, allowing capture of short repetitions in the data, while at the same time also yielding efficient compression of files exhibiting long data sequence repetitions.

The terms “computing device” is used herein to refer to any one or all of a variety of computers and computing devices, non-limiting examples of which include desktop computers, workstations, servers, cellular telephones, smart phones, wearable computing devices, personal or mobile multi-media players, personal data assistants (PDAs), laptop computers, tablet computers, smart books, palm-top computers, wireless electronic mail receivers, multimedia Internet enabled cellular telephones, wireless gaming controllers, mobile robots, and similar personal electronic devices that include a programmable processor and memory.

Various embodiments include methods, computing devices implementing such methods, and non-transitory processor-readable media storing processor-executable instructions implementing such methods for data deduplication using multi-chunk predictive sequencing. Conventional data deduplication methods store unique data chunks in memory and encode a data series or data file as a sequence of index values (typically a hash value) using a hash table that links each hash value to a pointer to the memory location of the corresponding unique data chunk. Various embodiments make use of a hash table stored in memory that includes data records (e.g., rows in the table) storing a hash value of a data chunk linked to a pointer that indicates the location in memory where the original data chunk is stored, and a second hash value of a predicted next (“sequential”) data chunk. By including a predicted sequential data chunk hash in each record of the hash table, an encoded data sequence can be generated for data streams or data files that is often more compact than conventional data deduplication techniques. Specifically, the encoded sequence representing the original data stream or data file may include a relatively small “true” value or indicator (instead of a hash value) so long as the sequence of data chunks in the data stream/file is consistent with the predicted next data chunk in the hash table. Only when the next chunk in the data stream/file differs from predicted next data chunk in the hash table does another hash value need to be included in the encoded sequence.

Embodiment methods may include encoding data streams or data files by identifying a current (sometimes referred to herein as a “first”) data chunk within a data stream or data file, and determining a current (i.e., first) hash value for the current data chunk using a hashing function. The computing device may begin encoding the data stream/file by using the current hash value as an entry in an encoded sequence to represent the current data chunk. The computing device may determine whether the determined current hash value is located within the hash table stored in a memory of the computing device. If the current hash value is not stored in the hash table, this indicates that this is the first encounter of this data chunk. Therefore, the computing device may store the data chuck in memory and generate a hash table entry (e.g., a new row in the table) that includes the current hash value associated with a pointer to the memory location of the data chunk. The computing device also identifies the next (e.g., second) data chunk in the data stream or data file, generates a corresponding hash value and stores that hash value in the newly created hash table entry as the predicted next data chunk hash value. The computing device also adds a true indicator (e.g., a “1”) in the encoded sequence representing the original data stream/file. The computing device then treats the next hash value as the current hash value and repeats the operation of determining whether that hash value is in the hash table.

If the current hash value is stored in the hash table, this indicates that the original data chunk has already been stored in memory at the memory location indicated by the pointer associated with the hash value stored in the hash table. In this situation, the computing device may add the hash value to the encoded sequence, or a true indicator if the current hash value is consistent with the predicted hash value indicated in the hash table for the preceding data chunk. The computing device may then identify the next (i.e., second) data chunk, determine its hash value (i.e., calculate the next or second hash value), and compare the next hash value to the predicted or sequence value stored in the hash table in association with the current hash value. If the determined next hash value and the predicted or sequence value match, the computing device may encode the next data chunk as a true indicator. If the determined next hash value and the predicted or sequence value do not match, the computing device may encode the next data chunk as a false indicator followed by the next hash value. The computing device then treats the next hash value as the current hash value and repeats the operation of determining whether that hash value is in the hash table.

Thus, the computing device only encodes another hash value when the next data chunk in the data stream/file differs from the predicted sequence of data chunks indicated in the hash table by the sequences hash values associated with each hash value.

In various embodiments, the computing device may adjust the address of a current pointer, tracking the current data chunk, and a next pointer, tracking the next data chunk. The current pointer may be changed to point to the next data chunk, and the next pointer may be changed to point to a subsequent data chunk. The computing device may then continue populating the hash table and encoding the data stream until the end of the data stream or data file is reached.

As mentioned above, data deduplication is typically performed storing unique chunks in memory and then storing the file as a series of index values (typically a hash) for each unique chunk linked to a pointer to the stored chunk of data or code. This process produces widely varying degrees of efficiency depending on the size of data chunks identified within a data stream or data file. Typical expected chunk lengths may vary from 1 kilobytes (KB) all the way to 100 KB. The widely differing expected data chunk lengths may be attributed to the fact that small chunk lengths are better suited for data sources with short repetitions, whereas long chunk lengths are better suited for data sources with long repetitions. Standard deduplication approaches are therefore limited to be either efficient for one or the other source type, but not both. The various embodiments address this problem through multi-chunk predictive encoding, enabling a computing device to efficiently process data streams having both large and small data chunk sequences.

The various embodiments, identify common data chunks in a data stream, and identify a next/subsequent chunk, determining (e.g., calculating) a hash value for both the chunk and the next chunk, storing the hash value of both the chunk and the next chunk along with a pointer to the address of the chunk in a hash table. Each next data chunk may have a positional relationship with the current data chunk within the data stream or data file and may represent a sequence of data chunks. By including the hash of the “next data chunk” as a sequence value in each data chunk entry, the hash table may “predict” the next data chunk. This predictive hashing may enable deduplicating a data sequence by storing a data series comprising a hash value of a data chunk followed by a bit/indicator (e.g., “1” or “0”) indicating whether the predicted next data chunk in the hash table is the correct. For example, the indicator may indicate whether or not the next data chunk is following the predicted pattern. If the predicted next data chunk in the hash table is not the same as the next data chunk in the data stream, then the hash value for the next chunk in the data is stored in the deduplicated data sequence.

To obtain the original data, or decode the deduplicated data stream, the sequence of hashes and indicators may be parsed by the processor of a computing device. When a hash is the next entry in the deduplicated sequence, the hash is used to look up the pointer to the corresponding chunk in the hash table, and the pointer is used to obtain the chunk from memory. Then the next entry in the deduplicated sequence will be an indicator. If the indicator is true or 1, the “next chunk” hash in the hash table is used to look up the pointer to the corresponding chunk in the hash table, and the pointer is used to obtain the chunk from memory. This will continue until a false or 0 indicator is encountered, at which point the next hash in the deduplicated sequence will be used as the hash table look up value.

Various embodiments may enable a computing device to perform operations for data deduplication using predictive multi-chunk data sequences in the hash table. Various embodiments may enable a computing device to perform operations for identifying small chunks of repeated data and storing a hash value of both the first chunk of data and the next chunk of data along with a pointer to the first chunk of data in a hash table.

Various embodiments may enable a computing device to perform operations for encoding a data stream as a series of hash-values of data chunks followed by a pattern indicator (e.g., a true or false indicator) if a hash value of the next chunk in the data stream matches a sequence value stored in the hash table. A small value may be used as the pattern indicator to encode this situation. For example, binary indicators may appear in the encoded sequence of the deduplicated data to indicate whether the sequence is being followed. As another example, if the next three chunks are consistent with the “next” chunk pattern stored in the hash table, the first hash value (index value) in the encoded sequence may be followed by the number “3.”

Various embodiments may enable a computing device to perform operations for inserting into the deduplicated data sequence a false indicator (e.g., 0) followed by a hash value corresponding to the next data chunk whenever the data chunk in the original data does not match the sequence value stored in the hash table entry for the previous chunk.

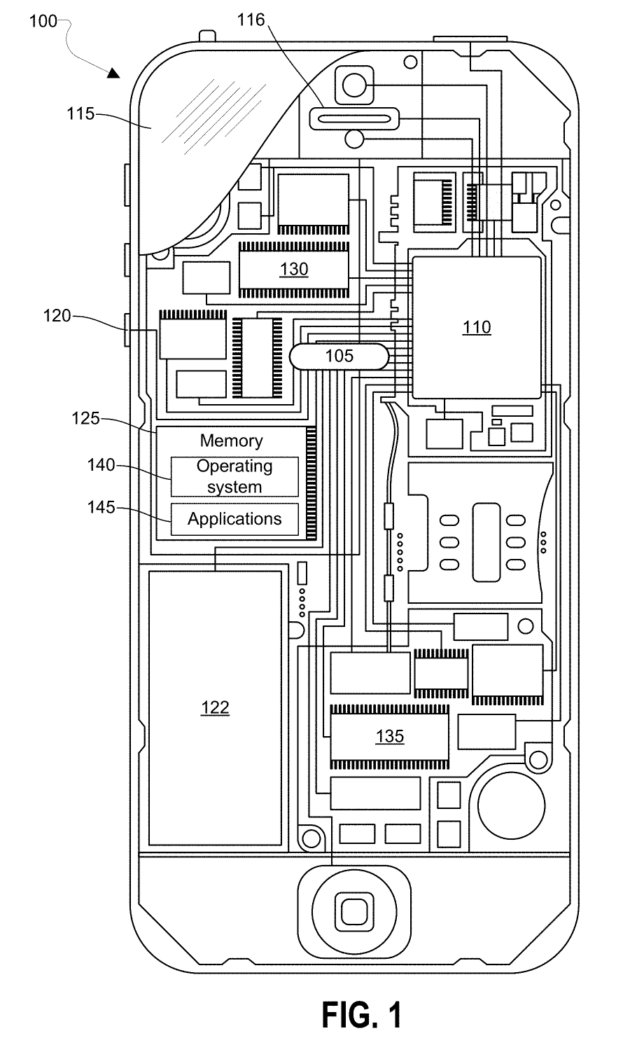

FIG. 1 illustrates a computing device 100 suitable for use with various embodiments. The computing device 100 is shown comprising hardware elements that can be electrically coupled via a bus 105 (or may otherwise be in communication, as appropriate). The hardware elements may include one or more processor(s) 110, including without limitation one or more general-purpose processors and/or one or more special-purpose processors (such as digital signal processing chips, graphics acceleration processors, and/or the like). The hardware elements may include one or more input devices, such as a touchscreen 115, a mouse, a keyboard, a keypad, a camera, a microphone and/or the like. The hardware elements may include one or more output devices, such as an interface 120 (e.g., a universal serial bus (USB)) for coupling to external output devices, a display device, a speaker 116, a printer, and/or the like.

The computing device 100 may further include (and/or be in communication with) one or more non-transitory storage devices such as non-volatile memory 125, which can include, without limitation, local and/or network accessible storage, and/or can include, without limitation, a disk drive, a drive array, an optical storage device, solid-state storage device such as a random access memory (RAM) and/or a read-only memory (ROM), which can be programmable, flash-updateable, and/or the like. Such storage devices may be configured to implement any appropriate data stores, including without limitation, various file systems, database structures, and/or the like.

The computing device 100 may also include a communications subsystem 130, which can include without limitation a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. The communications subsystem 130 may permit data to be exchanged with a network, other devices, and/or any other devices described herein. The computing device 100 may further include a volatile memory 135, which may include a RAM or ROM device as described above. The memory 135 may store processor-executable-instructions in the form of an operating system 140 and application software (applications) 145, as well as data supporting the execution of the operating system 140 and applications 145. The computing device 100 may be a mobile computing device or a non-mobile computing device, and may have wireless and/or wired network connections.

The computing device 100 may include a power source 122 coupled to the processor 110, such as a disposable or rechargeable battery. The rechargeable battery may also be coupled to the peripheral device connection port to receive a charging current from a source external to the computing device 100.

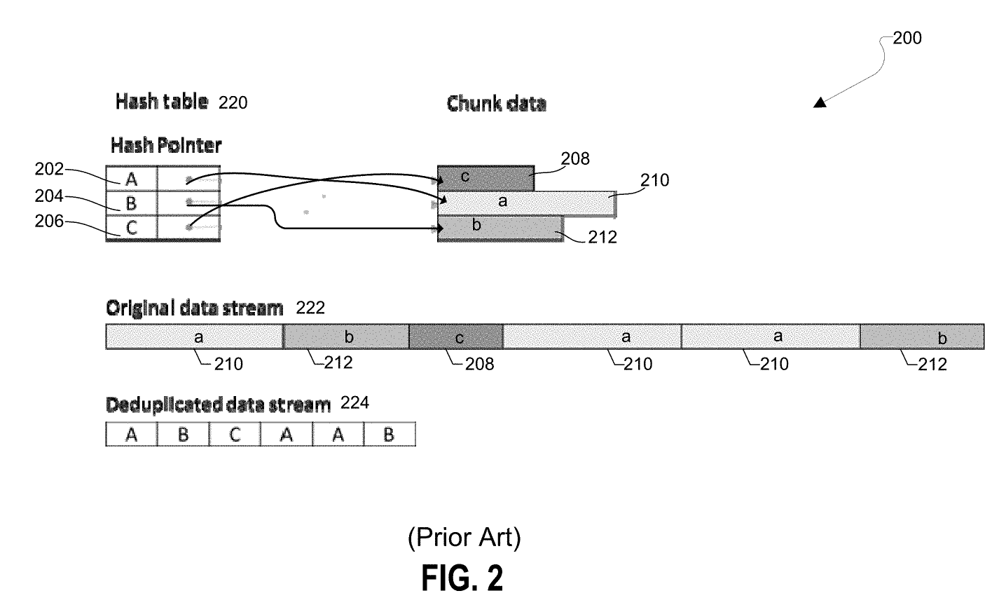

FIG. 2 is a block diagram 200 illustrating encoding of a data stream according to conventional methods. With reference to FIGS. 1-2, a data encoding may be implemented on a computing device (e.g., computing device 100) and carried out by a processor (e.g., processor 110) in communication with the memory (e.g., memory 135). Standard deduplication algorithms such as that depicted in FIG. 2, may identify a data marker sequence and split a data stream into chunks of variable length delineated by the data marker sequence. The data stream 222 may be split into data chunks 208, 210, and 212 based on positions of the data marker within the data stream, as well as the terminating ends of the data stream 222. For purposes of illustration, consider an example in which the original source data stream 222 contains the sequence of binary data 0101101001110001101110001011010001011010011100. For purposes of this example, the computing device may use the marker sequence 00, in which case the data stream is split into the 6 chunks 010110100, 11100, 011011100, 010110100, 010110100, 11100.

In the example illustrated in FIG. 2, only three of the six data chunks 208, 210, and 212 within data stream 222 are distinct. To identify distinct data chunks, the processor of a computing device may calculate hash values 202, 204, 206 for each data chunk 208, 210, and 212. The computing device may store the hash values 202, 204, 206 with a pointer to the actual data chunk 208, 210, and 212 in a hash table 220. The hash value serves as a unique index for the data chunk that can be used for finding a record within a hash table. In the example, the hash values 202, 204, 206 for the three distinct chunks are a, b, and c. The deduplicated data stream 224 is then simply an encoded sequence of these hash values, namely A, B, C, A, A, B corresponding to the data chunks a, b, c, a, a, b, in the example of conventional deduplication. The computing device stores the hash table 220, the unique chunk data 208, 210, 212, and the deduplicated data stream in memory.

The problem with this approach is that it requires careful tuning of the expected (i.e., average) data chunk length in order for the deduplication to yield good storage reduction. In particular, for data streams with short data repetitions, the expected chunk length should be chosen to be short. For data streams with long data repetitions, the expected chunk length should be chosen to be long. As consequence, typical expected chunk lengths may need to be chosen anywhere from 1 KB all the way to 100 KB depending on the data stream or data file.

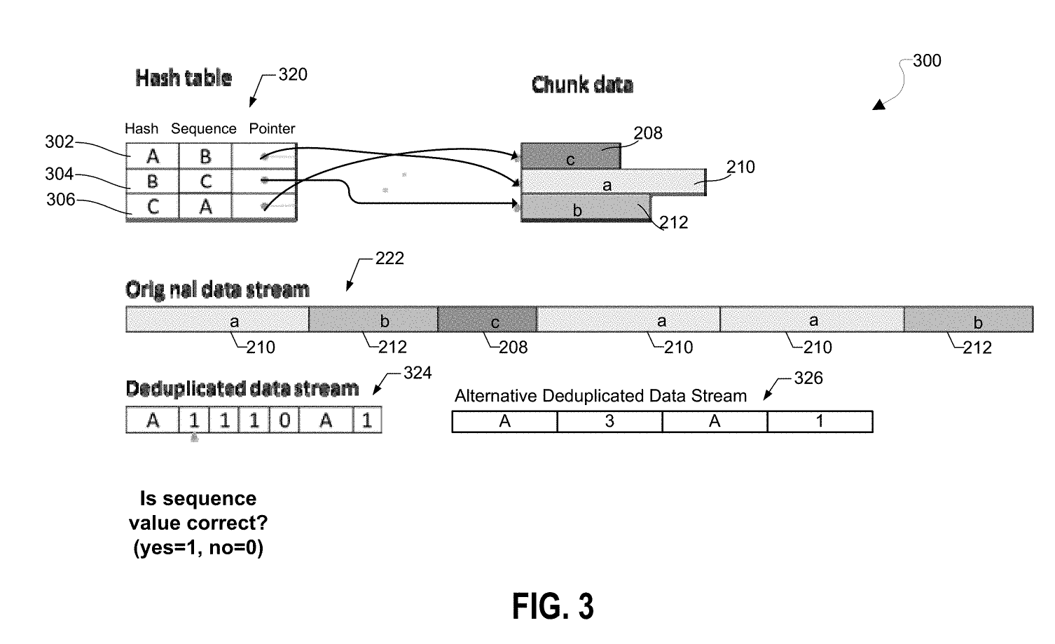

FIG. 3 illustrates a block diagram 300 of encoding a data stream according to various embodiments. With reference to FIGS. 1-3, the embodiment data encoding may be implemented on a computing device (e.g., computing device 100) and carried out by a processor (e.g., processor 110) in communication with the memory (e.g., memory 135).

Unlike conventional methods, the various embodiments implement multi-chunk predictive encoding that is adaptive to predicted data chunks of varying length. Thus, the various embodiments may storage-efficiently deduplicate both short and long data repetitions. The various embodiments provide methods that strike a balance between the storage benefits of processing small data chunks with the efficiency of benefits of encoding large data chunk.

In various embodiments, the hash table 320 may store the hash values A 302, B 304, and C 306 and pointers to the associated distinct data chunks a 210, b 212, and c 208 of the original data stream 222. In association with each distinct data chunk 208, 210, 212, a sequence value identifying of the next data chunk that was seen when first parsing the original source data stream 222 may also be stored. For example, the hash values 302, 304, 306 of the data chunks 210, 212, 208, respectively, in the original data stream 222 are A, B, C, A, A, B. When the computing device first encounters data chunk a having the hash value A 210 during data stream parsing, the data chunk a 208 is followed by b data chunk 212 having the hash value B. Therefore, the next value for the hash value 302 entry of A is hash value B. When the computing device first encounters data chunk b 212, the b data chunk having a hash value B is followed by data chunk c 208. Thus, in the entry in the hash table starting with the hash B, the sequence value for hash value B in the table is the hash C to the data chunk 208. Similarly, when the computing device first encounters data chunk c, the data chunk 208 is followed by data chunk a 210. Thus, the sequence value for the hash table entry for hash value C is the hash value A for data chunk a 210. Each hash table entry includes a pointer to the data chunk associated with the leading hash in the entry, but not the sequence value.

In various embodiments, the deduplicated data stream 324 may be constructed using the hash values of encountered data chunks along with the stored sequence value (e.g., hash value) of the next data chunk in a predicted sequence. The first data chunk in the original data stream 222 may be encoded using the calculated hash value of the data chunk. Therefore, the first encoded data in each deduplicated data stream 324 may be a hash value of the first encountered data chunk. In the example illustrated in FIG. 3, hash value A 302 is the first piece of encoded data in the deduplicated data stream 324. Rather than continuing with encoding the original data stream 222 using each hash value 302, 304, 306 as associated data chunks appear, the computing device may merely insert an indicator as to whether the predicted sequence (i.e., the order in which the data chunks were first encountered) is followed in the current order of data chunks within the data stream or data file. For example, the computing device may access the hash table 320 to retrieve the sequence value for the hash value of A 302. The sequence value for hash value A 302 is the hash value of B 304. If the next data chunk encountered is data chunk b 212 corresponding to the hash value B 304, then the computing device encodes the next data chunk as a true indicator, indicating that the sequence is followed as predicted by the linked relationships between hash values stored in the hash table. In the example illustrated in FIG. 3, the indicator is a binary indicator, in which a “1” indicates that the predicting sequence is followed and a “0” indicates an aberration from the predicted sequence.

In some embodiments, such as illustrated by alternative deduplication stream 326, the indicator may provide a number of data chunks that follow predicted sequence. For example, the order of data chunks within the illustrated original data stream 222 follows the predicted pattern of data chunk a 208->data chunk b 210; data chunk b 210->data chunk c 212; data chunk c 212->data chunk a 208, as indicated by the hash values and associated sequence values of A 302->B 304; B 304->C 306; C 3-6->A 302, stored within hash table 320. The order then diverges from the predicted sequence such that a second data chunk a 208 follows another data chunk a 208. As such, the predicted sequence is followed for three steps/links/iterations. Rather than indicating that each data chunk follows the predicted sequence using a binary indicator, the computing device may use an alphanumeric indicator to indicate a number of steps/links/iterations for which the pattern is followed. Once the predicted sequence is broken, the computing device may encode the next data chunk as a calculated hash value. In such embodiments, the true indicator may be a value that quantifies the positional relationship between the current data chunk and the next data chunk that does not have a corresponding hash value that matches the sequence value of the preceding data chunk.

The computing device may maintain a pointer to the current data chunk as it moves though the data stream 222. The pointer to the current data chunk indicates which data chunk should be hashed to obtain the relevant hash value. A next pointer may point to the subsequent data chunk, which the computing device is analyzing for sequence honoring. In the example, the current pointer may begin at data chunk a 208 and the next pointer may begin pointing to data chunk b 210. The true indicator is inserted into the deduplication data stream 324, and the sequence for hash value B 304 may be retrieved. The hash table 320 indicates that the sequence value is the hash value C 306, if the next data chunk is data chunk c 212 then a true indicator is use to encode the next data chunk and the current pointer is advanced. Once the next data chunk is encoded, the current pointer advances along the data stream and points to the next data chunk. The next pointer is similarly advanced to point to a subsequent data chunk in the data stream or data file. This process may continue until a data chunk is encountered for which the resulting hash value does not match the relevant sequence value in the hash table 320

In various embodiments, if the next encountered data chunk does not match the sequence value of the current data chunk then a false indicator may be inserted into the deduplicated data stream 324 or 326 to indicated that the predicted sequence was not followed. Further, the computing device may encode the next data chunk as the actual calculated next hash value of the aberrant data chunk. The processor may then begin sequence prediction again. The encoding process may continue until the end of the data stream or data file. In the example, this yields the deduplicated data stream 324 A, 1, 1, 1, 0, A, 1 or alternative deduplicated data stream 326 of A, 3, A, 1. The computing device may store the hash table 320, the unique chunk data 208, 210, 212, and the deduplicated data stream 324 or 326 in memory or other storage.

In some embodiments, the sequence value stored in the hash table 320 may be a pointer rather than a hash value. The sequence value pointer may point to the address of a predicted next data chunk. For example, a sequence value pointer stored in the hash table 320 in association with hash value A 302 may point to an address of data chunk b 210. Such embodiments may increase the look-up time of next data chunk comparisons because the computing device may have to compare the data stored in the address of the next pointer, which tracks the next data chunk during encoding, to the data stored in the address indicated by the sequence value pointer. Thus, this embodiment may require a memory access. If the two pointers address the same data chunk, then a match is found and the true indicator may be encoded representing the next data chunk. Such embodiments may not require the calculation of a hash vale for the data chunk to which the next pointer is pointing until such time as the current pointer advances and is addressed to the same data chunk.

The various embodiments may provide resource savings over known methods for data deduplication. Compression efficiency may be derived from long multi-chunk repetitions (such as a followed by b in the example). Such long repetitions only need be stored once using the sequence value in the hash table. Subsequent appearances of the repeated data chunks may result in very efficient encodings consisting of only the indicators. As a consequence, the expected data chunk length may be chosen to be quite short, allowing for the capture short repetitions in the data source, while at the same time also yielding efficient compression of long repetitions.

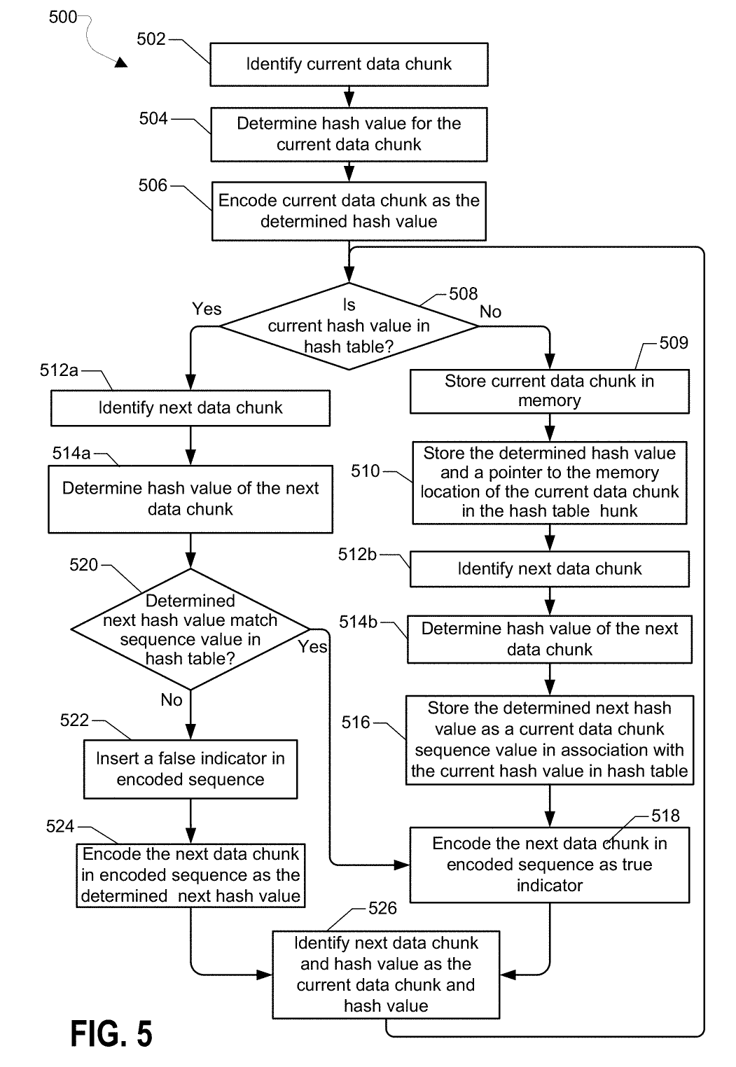

In some embodiments, the computing device may have no foreknowledge of the data chunks resident in an incoming data stream. In such embodiments, the computing device may calculate hash values for identified data chunks and may populate a hash table with the calculated hash values, sequence values, and pointers to the data chunks, as data chunks are parsed. Concurrently, the data chunks may be encoded into a compressed, encoded data stream for storage. Such embodiments are disclosed with further detail with reference to FIG. 5 and method 500. These embodiments may be beneficial in implementations in which the content of data streams varies widely form session to session and even throughout the course of a single streaming session.

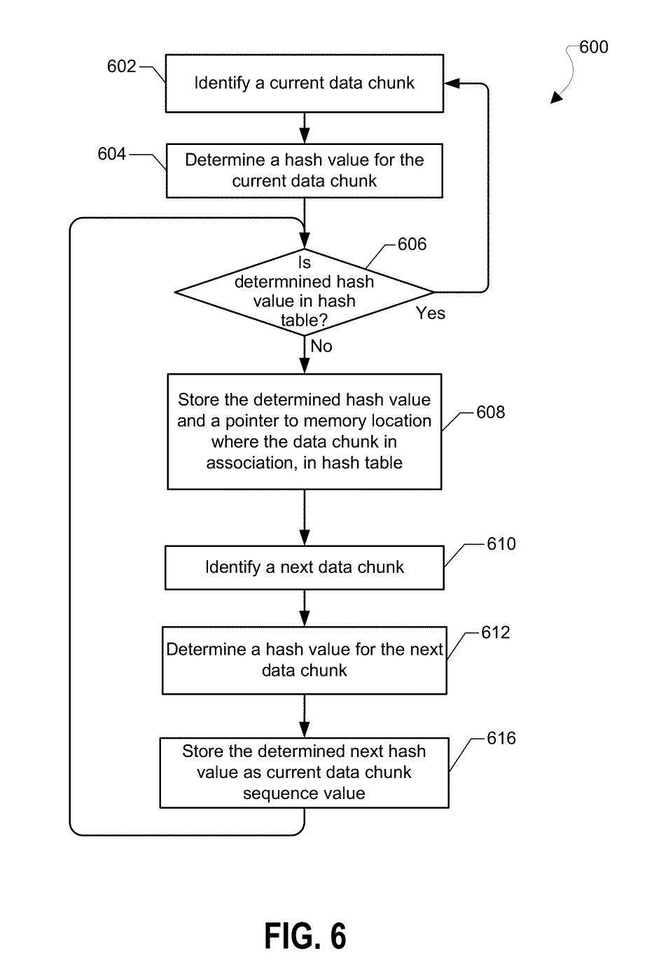

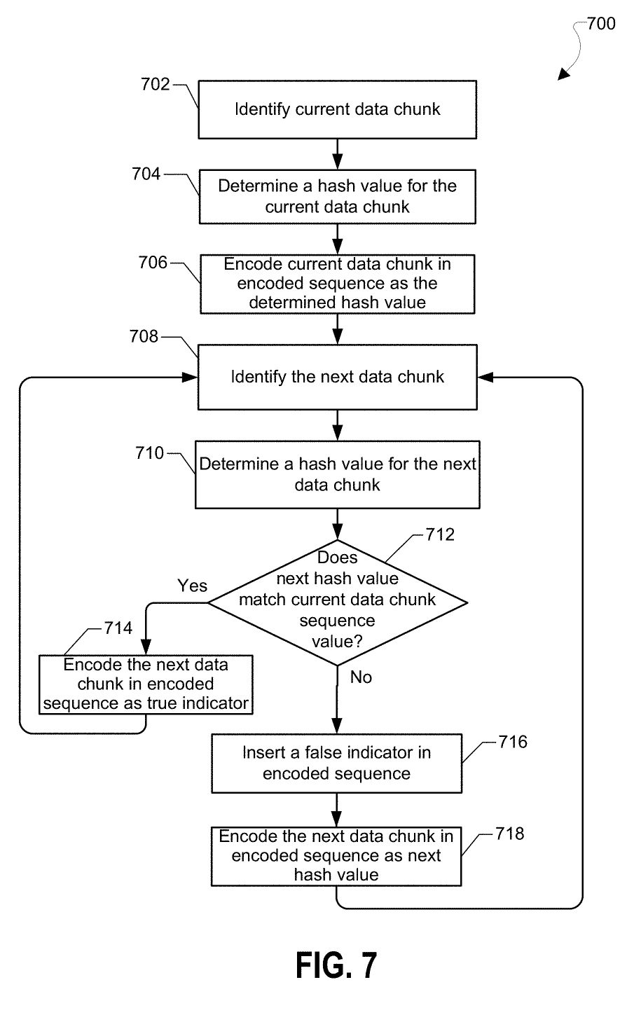

In some embodiments, the computing device may have some or total foreknowledge of the contents of a data stream or data file. In such embodiments, the computing device may train itself on known instances of the data stream such as by parsing received files and documents. The computing device may generate and populate a hash table prior to active encoding. Such embodiments are described in greater detail with reference to FIG. 6 and method 600. Further, encoding may be performed at a later time, using the previously populated hash table to reduce look up and processing times. Such embodiments are described in greater detail with reference to FIG. 7 and method 700. The various embodiments enable decoding of previously encoded data streams by reversing the operations discussed with reference to FIGS. 3, 5, and 7.

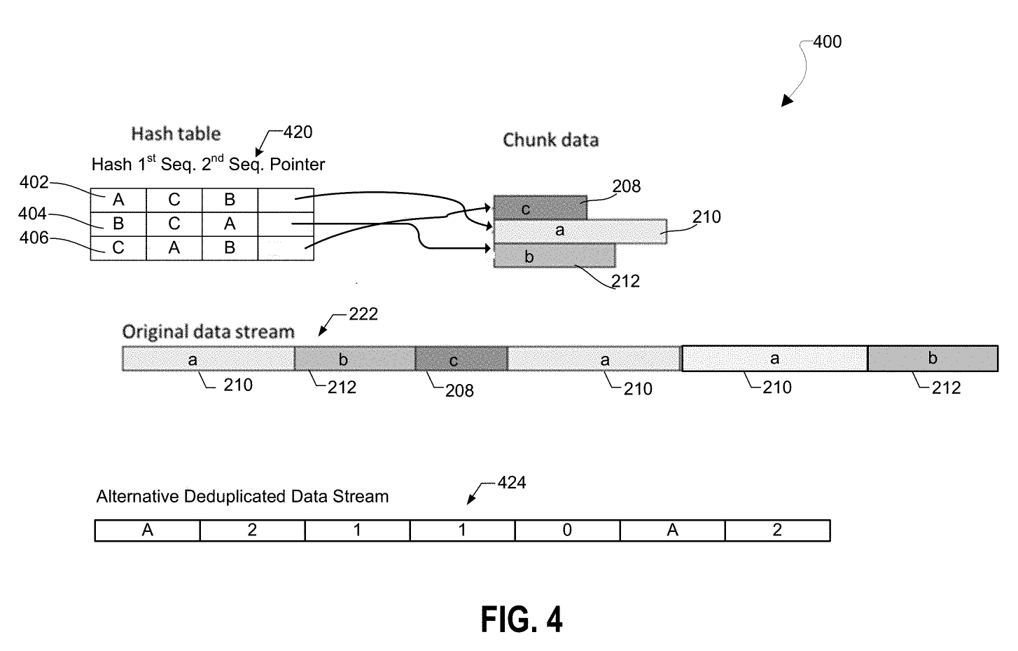

FIG. 4 is a block diagram illustrating encoding a data stream according to various embodiments. With reference to FIGS. 1-4, a data encoding method 400 may be implemented on a computing device (e.g., computing device 100) and carried out by a processor (e.g., processor 110) in communication with the memory (e.g., memory 135). In some embodiments, the indicators may be alphanumeric values indicating an offset of the current chunk to the next data chunk in a sequence. In such embodiments, the hash table 420 may be larger than in the example illustrated in FIG. 3, because the hash table 420 may store multiple alternate sequences of sequence values. When the next chunk pointer points to a data chunk matching one of the stored sequence values for an entry is encountered, the true indicator is encoded representing the next data chunk in the deduplicated data stream 424. The true indicator may indicate the order of the sequence value of the next data chunk. In such embodiments, the first sequence value may be the hash value of the next data chunk encountered following data chunk a 208, when a data stream was first parsed, or the hash table 420 was first populated. Similarly, the second sequence value may be the hash value of the next data chunk that was next encountered following data chunk a 208 during initial parsing of the data stream or data file. In the illustrated example, a data chunk a 210 having an entry in the hash table 420 with a hash value A 402 may have a first sequence value C, and a second sequence value B. Similarly, a data chunk b 212 having an entry in the hash table 420 with a hash value B 404 may have a first sequence value C, and a second sequence value A. Similarly, a data chunk c 208 having an entry in the hash table 420 with a hash value C 406 may have a first sequence value A, and a second sequence value B. As a data stream is encoded, the computing device may encode data chunks according to which sequence value option they represent. If an encountered next data chunk has a hash value matching the first sequence option, then a “1” may be encoded. A “2” may be encoded to indicate that the second sequence value option corresponds to the encountered next data chunk, and so on. In some embodiments, the indicator may be an offset rather than a sequence value option number.

Embodiments such as those illustrated in FIG. 4 may include hash tables that vary in size according to the implementation limits of an executing computing device. The number of columns in the hash table may represent a balance between the decoding speed of encoding large sequences of data chunks with a single numeric true indicator versus the reduction drag on processing speed of encoding operations as the hash table grows larger. For example, a hash table having a large number of columns may cause encoding operations to lag as the processor is forced to check numerous potential sequences (e.g., checking the sequence value of each additional column for the index hash value against the hash value of the occurring data chunk). However, hash tables having only a few additional columns may present significantly increased decoding times while imposing little additional processing load during encoding.

FIG. 5 illustrates a process flow diagram of an embodiment method for data deduplication using multi-chunk predictive encoding in which data chunks are identified and stored in memory, a hash table of hash values, predictive sequence values and pointers to memory locations of data chunks are generated, and an encoded sequence is generated representing the original data stream or data file. With reference to FIGS. 1-5, the method 500 may be implemented on a computing device (e.g., computing device 100) and carried out by a processor (e.g., processor 110) in communication with the memory (e.g., memory 135).

The processor of the computing device may identify a current data chunk within a data stream or data file in block 502. In various embodiments, identifying data chunks within a data stream or data file may include identifying one or more data markers within the data stream/file, and assigning data delineated by the one or more data markers as a data chunk. In some embodiments, the processor may assign data chunks, which may include data markers, such as terminating data markers. Data markers may range in size from a few bits to several kilobytes depending on the type of data within the data stream or data file. In some embodiments, these data markers may be appended to the end of each identified data chunk to eliminate the need to encode the data markers separately.

The processor of the computing device may determine a current hash value for the current data chunk in block 504. The processor may execute a hashing function on the data chunk to produce the hash value. Various hashing functions may be utilized according to various embodiments. However, because the number of distinct data chunks identified may be large, hashing functions that present a low risk of collision (i.e., the same hash value being generated for different data blocks) are preferred in order to reduce the likelihood of errors during decoding.

The processor of the computing device may encode the current data chunk as the determined current hash value in block 506. In other words, the computing device may use the current hash value in an encoded sequence to indicate that the current data chunk should be retrieved and included at the current position when regenerating the original data stream or data file. Thus, the first value in each encoded sequence may be a first hash value for the first data chunk encoded (e.g., the current data chunk). The next data chunk may be the second data chunk encoded and represent the second encoded value or second hash value depending on whether the predicted sequence is followed.

In determination block 508, the processor of the computing device may determine whether the determined current hash value is located within a hash table stored in a memory of the computing device. The computing device may perform a look-up on the hash table to ascertain whether the current hash value is present as a primary entry within the hash table. Primary entries may be those entries in which the hash value and a pointer to the corresponding data chunk are stored. For example, in some embodiments the current hash value may be a function used as an index value for finding records within the hash table. An entry for a sequence value associated with the primary entry may not considered a primary entry.

In response to determining that the determined current hash value is located within the hash table (i.e., determination block 508=“Yes”), the processor may identify the next data chunk in block 512a. In some embodiments, this may be accomplished by scanning the data stream or data file to locate the next instance of a data marker. In some embodiments, the processor may examine the data chunk to which a next chunk pointer is addressed. The next data chunk may have a positional relationship to the current data chunk within the data stream or data file. For example, the next chunk pointer may be addressed to a data chunk lying contiguous to the current data chunk or anywhere subsequent to the current data chunk along the data stream or data file. The positional relationship between a current data chunk and the next data chunk may be quantified as an offset or number of other data chunks positioned between the current data chunk and the next data chunk within the data stream or data file.

The processor of the computing device may determine a next hash value for the next data chunk in block 514a. Generating such a hash value in block 514a may be accomplished in a substantially similar manner to the operations discussed with reference to block 504.

In determination block 520, the processor of the computing device may determine whether the determined next hash value matches the current data chunk sequence value. For example, the processor may compare the determined next hash value to the sequence value stored in the hash table in association with the current hash value.

In response to determining that the determined next hash value matches the current data chunk sequence value (i.e., determination block 520=“Yes”), the processor may encode the next data chunk in the encoded sequence as a true indicator in block 518. In various embodiments, the indicator may be a binary value, such as 0 for false and 1 for true, or vice versa. In some embodiments, the indicator may be a numeric indicator of a sequence value option (e.g., a column number within the hash table) or an offset between the last data chunk encoded with a hash value and the current data chunk (e.g., a numeric quantification of the positional relationship).

In some embodiments, the true indicator may also indicate the number of data chunks for which the predicted sequence holds true. For example, if the encountered data chunks match correlating sequence values stored in the hash table three times in a row but the fourth data chunk has a determined hash value that does not match the appropriate sequence value, then the true indicator may be 3. Such embodiments may require that the processor evaluates the data stream or data file twice. A first pass may evaluate the extent to which the sequence is followed, and may optionally insert flags before data chunks that do not follow the predicted sequence. A second pass may encode the data stream or data file, counting the number of data chunks between a current data chunk and a flag, and encoding a true indicator that quantifies the number of interim data chunks. Similarly, the processor may generate the encoded stream using true binary flags on the first pass, and may then evaluate the encoded stream, consolidating binary flags into a single true indicator that represents the number of counted true binary flags in a row.

In response to determining that the determined next hash value does not match the current data chunk sequence value (i.e., determination block 520=“No”), the processor may insert a false indicator in a current location in the encoded sequence in block 522. For example, the processor may insert a false indicator at a current location in the encoded sequence representing the data stream or data file. The processor may then encode the next data chunk in the encoded sequence as the determined next hash value in block 524. By encoding a false indicator, a computing device using the encoded sequence, hash table and stored data chunks to recover or retrieve the original data stream or data file is informed that the predicted sequence in the hash table is not correct and that the computing device should look to the next element in the encoded sequence to obtain the hash value to be used in the hash table to look up a pointer to the memory address where the next data chunk is stored.

In response to determining that the determined current hash value is not located within the hash table (i.e., determination block 508=“No”), indicating that this is the first time the current data chunk has been encountered, the processor may store the current data chunk in memory in block 509, and store the determined current hash value and a pointer to the memory location of the current data chunk in association with each other in the hash table in block 510. In various embodiments, each entry within the hash table (e.g., each row in a table) may include a determined hash value, a pointer to the memory location of the data chunk from which the hash value was determined (e.g., calculated), and a sequence value in which a hash value of the next data chunk will be saved (see block 516).

The processor of the computing device may identify a next data chunk within the data stream or data file in block 512b. As in block 512a, the processor may examine the data chunk to which a next chunk pointer is addressed. The next chunk pointer may be addressed to a data chunk that is contiguous to the current data chunk in a data stream or within memory of data file, or having a positional relationship that is anywhere subsequent to the current data chunk along the data stream or data file.

The processor of the computing device may determine a next hash value for the next data chunk in block 514b. The operations in block 514b may be implemented in a substantially similar manner to the operations discussed with reference to block 504.

The processor may store the determined next hash value as the current data chunk sequence value in the hash table in block 516. The sequence value may be stored in the hash table in association with or linked to the current hash value (e.g., in a column within the same row in a data table as the current hash value). For example, the next hash value may be stored in a sequence value field initialized during the generation of a new hash table entry for the current hash value in block 510.

The processor may encode the next data chunk as a true indicator in block 518.

After the next data chunk is encoded in the encoded sequence as either as a true indicator in block 518 or a combination of a false indicator in block 522 and the determined next hash value in block 524, the processor may perform similar operations on the next data chuck, such as by identifying the next data chunk as the current data chunk and the next hash value as the current hash value in block 526 and repeat the operations in blocks 508 to 526 working with the new current data block and new current hash value. In some embodiments, after each data chunk is encoded, the processor may move the current pointer forward in the data stream or data file to point to the same data chunk as the next pointer. The next pointer may then be advanced to a subsequent data chunk within the received data stream or data file, such as a contiguous data chunk.

FIG. 6 illustrates a process flow diagram of an embodiment method for storing data chunks in memory and generating a hash table of hash values, predicted hash values and pointers to memory for use in multi-chunk predictive encoding. With reference to FIGS. 1-6, the method 600 may be implemented on a computing device (e.g., computing device 100) and carried out by a processor (e.g., processor 110) in communication with the memory (e.g., memory 135).

The processor of the computing device may identify a current data chunk within a data stream in block 602. The operations of block 602 may be implemented in substantially the same manner as the operations discussed with reference to block 502.

The processor of the computing device may determine a current hash value for the current data chunk in block 604. The operations of block 604 may be implemented in substantially the same manner as the operations discussed with reference to block 504.

In determination block 606, the processor of the computing device may determine whether the determined current hash value is located within a hash table stored in a memory of the computing device. If the current hash value is within the hash table, this indicates that the current data chunk has been stored in memory and the pointer to that memory location is included in the hash table linked to the current hash value. If the current hash value is not located within the hash table, this indicates that the current data chunk has not been encountered before, and therefore is not stored in memory. The operations of determination block 606 may be implemented in substantially the same manner as the operations discussed with reference to determination block 508.

In response to determining that the determined current hash value is located within the hash table stored in the memory of the computing device (i.e., determination block 606=“Yes”), the processor may identify a next data chunk within the data stream or data file as the current data chunk in block 602 and repeat the operations of blocks 604 and 606 for that data chunk.

In response to determining that the determined current hash value is not located within the hash table stored in the memory of the computing device (i.e., determination block 606=“No”), the processor may store the data chunk in memory, and store as a new entry in the hash table the current hash value along with a pointer to the memory location where a copy of the data chunk is stored in block 608. The operations of block 608 may be implemented in substantially the same manner as the operations discussed with reference to blocks 509 and 510.

The processor of the computing device may identify the next data chunk in the data stream or data file in block 610, and determine a next hash value for the that data chunk in block 612. The operations of block 612 may be implemented in substantially the same manner as the operations discussed with reference to block 504.

In block 616, the processor may store the determined next hash value as the sequence value for the current data chunk (i.e., the current data chunk sequence value). The processor may then determine whether the next hash value is in the hash table in determination block 606 and repeat the operations of blocks 608-616.

FIG. 7 illustrates a process flow diagram of an embodiment method for encoding data into a deduplicated encoded sequence using multi-chunk predictive encoding in which data chunks have been stored in memory and a hash table including pointers to the data chunks has been generated according to some embodiments. In such implementations, there is no need to store data chunks in memory or to generate the hash table. Instead, the previously generated hash table is used to generate an encoded sequence of hash values and true/false indicators representative of a data sequence or data file. With reference to FIGS. 1-7, the method 700 may be implemented on a computing device (e.g., computing device 100) and carried out by a processor (e.g., processor 110) in communication with the memory (e.g., memory 135).

The processor of the computing device may identify a current data chunk within a data stream or data file in block 702. The operations of block 702 may be implemented in substantially the same manner as the operations discussed with reference to block 502.

The processor of the computing device may determine a current hash value for the current data chunk in block 704. The operations of block 704 may be implemented in substantially the same manner as the operations discussed with reference to block 504.

The processor of the computing device may encode the current data chunk in the encoded sequence as the determined current hash value in block 706. The operations of block 706 may be implemented in substantially the same manner as the operations discussed with reference to block 506.

The processor of the computing device may identify a next data chunk within the data stream in block 708. The operations of block 708 may be implemented in substantially the same manner as the operations discussed with reference to block 512a.

The processor of the computing device may determine a next hash value for the identified data chunk in block 710. The operations of block 710 may be implemented in substantially the same manner as the operations discussed with reference to block 514a.

In determination block 712, the processor of the computing device may determine whether the determined next hash value matches a current data chunk sequence value stored in the hash table in association with the hash value of the current hash value. For example, the computing device may compare the determined next hash value to the current data chunk sequence value stored in the hash table associated with the current hash value. Based on the result of this comparison the computing device may determine whether the next hash value matches the stored current data chunk sequence value.

In response to determining that the determined next hash value matches the current data chunk sequence value (i.e., determination block 712=“Yes”), the processor may encode the next data chunk in the encoded sequence as a true indicator in block 714, and then identify the next data chunk in block 708.

In response to determining that the determined next hash value does not match the current data chunk sequence value (i.e., determination block 712=“No”), the processor may insert a false indicator in the current location in the encoded sequence in block 716. For example, the processor may insert a false indicator at a current location in the encoded sequence representing the original data stream or data file. The processor of the computing device may then encode the next data chunk as the calculated next hash value in the encoded sequence in block 718. The processor may then identify the next data chunk in block 708 and repeat the operations of blocks 708-718 to encode the data stream or data file.

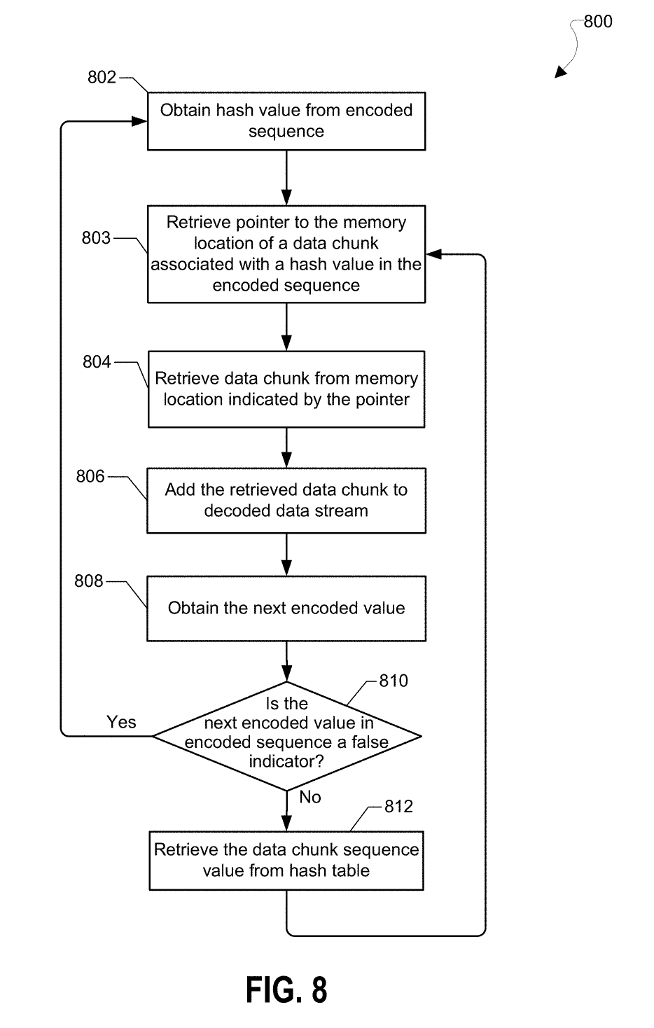

FIG. 8 illustrates a process flow diagram of an embodiment method for retrieving or recreating a data stream or data file from a de-duplicated data stream according to various embodiments. Effectively, the method 800 reverses the process of deduplication in methods 500 and 700 to retrieve or recreate the original data stream or data file. The method 800 may be implemented on a computing device 100 and carried out by a processor 110 in communication with the communications subsystem 130, and the memory 135.

The processor of the computing device may obtain a current hash value from the encoded data stream in block 802. As described above, the current hash value in the encoded sequence, such as deduplicated data stream 324, may be a hash value corresponding to a data chunk in the original data stream or data file.

In block 803, the processor may retrieve a pointer to a memory location storing a data chunk associated with the obtained hash value within the encoded sequence representing an original data stream or data file. In some embodiments, the obtained hash value may serve as an index or lookup value within the hash table. The pointer to the memory location of the corresponding data chunk may be a data element within the record corresponding to, linked to, or including the obtained hash value.

The processor may retrieve from memory of the computing device the data chunk associated with the current hash value as indicated by the retrieved pointer in block 804.

The processor may add the current data chunk to the decoded (e.g., retrieved/regenerated) data stream or data file in block 806. The retrieved data chunk may be added to buffer or memory region used to decode or reassemble data stream or data file.

In block 808, the processor of the computing device may identify a next encoded value in the encoded sequence. As described above, the next encoded data may be an indicator indicating whether the data chunk corresponding to the indicator follows the predicted data chunk sequence stored in the hash table.

In determination block 810, the processor of the computing device may determine whether the next encoded value is a false indicator. For example, a false indicator may be equal to zero or null to indicate that the predicted sequence was not followed and that the next data chunk is not represented by the sequence value.

In response to determining that the next encoded value is not a false indicator (i.e., determination block 810=“No”), the processor may retrieve, from the hash table, a next hash value stored as the sequence value for the current data chunk (i.e., current data chunk sequence value) in block 812. In other words, a true indicator informs the processor that the sequence value associated with the previously obtained hash value was the next data chunk in the original data stream or data file, and thus is to be used to as a look up value in the hash table to obtain the pointer to the next data chunk. Therefore, the processor may retrieve a hash value that matches the current data chunk sequence value from the hash table to obtain the pointer to the memory location of the corresponding data chunk in block 803, retrieve the next data chunk from memory using the obtained pointer in block 804, add the data chunk to the decoded data stream or data file in block 806, and repeat the operations in blocks 808 and 810 so long as the next encoded value is not a false indicator.

In response to determining that the next encoded value is a false indicator (i.e., determination block 810=“Yes”), the processor may obtain the next hash value from the encoded sequence in block 802 and repeat the operations in blocks 803-812.

The operations of the method 800 may be repeated until the entire encoded sequence has been decoded and the complete original data stream or data file has been retrieved or recreated.

To restate, the various embodiments may include a method executable by a processor of a computing device for encoding data using multi-chunk predictive encoding. The method may include determining, by a processor of a computing device, a first hash value for a first data chunk of a data stream or data file. The processor may encode the first data chunk as the determined first hash value. The processor may then determine whether the determined first hash value is located within a hash table stored in a memory of the computing device, and may perform additional operations in response to determining that the determined first hash value is located within the hash table stored in the memory of the computing device. Such operations may include the processor determining a second hash value for a second data chunk having a positional relationship to the first data chunk within the data stream or data file. The processor may also determine whether the determined second hash value matches a first data chunk sequence value stored in the hash table in association with the first hash value. The processor may encode the second data chunk in an encoded sequence as a true indicator in response to determining that the determined second hash value matches the first data chunk sequence value.

The terms “current” and “next” are used herein to denote order of analysis within a data stream being encoded or decoded. In some situations, these terms may be synonymous with “first” and “second” or “third” and “fourth” and so on. The use of “current” and “next” or “first” and “second” is not intended to limit the data chunks to a specific configuration within the data stream or data file. Nor are the terms intended to limit the analysis to starting at the beginning of a data stream or any other fixed position.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, (e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of storing data in a deduplicated format, comprising:
determining, by a processor of a computing device, a first hash value for a first data chunk of a data stream or data file;
encoding, by the processor, the first data chunk as the determined first hash value;
determining, by the processor, whether the determined first hash value is located within a hash table stored in a memory of the computing device; and
in response to determining that the determined first hash value is located within the hash table stored in the memory of the computing device:
determining, by the processor, a second hash value for a second data chunk having a positional relationship to the first data chunk within the data stream or data file;
determining, by the processor, whether the determined second hash value matches a first data chunk sequence value stored in the hash table in association with the first hash value; and
encoding, by the processor, the second data chunk in an encoded sequence as a true indicator in response to determining that the determined second hash value matches the first data chunk sequence value.

2. The method of claim 1, further comprising assigning, by the processor, data delineated by one or more data markers within the data stream or data file as a data chunk.

3. The method of claim 2, wherein assigning the data delineated by the one or more data markers within the data stream or data file as a data chunk comprises assigning, by the processor, the data delineated by the one or more data markers and at least one data marker as a data chunk.

4. The method of claim 1, further comprising in response to determining that the determined first hash value is not located within the hash table stored in the memory of the computing device:
storing the determined first hash value and a pointer to a location in memory of the first data chunk in association in the hash table;
determining, by the processor, a second hash value for a second data chunk having a positional relationship to the first data chunk within the data stream or data file; and
storing the determined second hash value in the hash table as a first data chunk sequence value associated with the first hash value.

5. The method of claim 1, further comprising in response to determining that the determined second hash value does not match the first data chunk sequence value:
inserting, by the processor, a false indicator at a current location in the encoded sequence; and
encoding, by the processor, the second data chunk in the encoded sequence as the determined second hash value.

6. The method of claim 1, wherein the true indicator is a numeral indicating an offset of a current data chunk from a next data chunk that has a determined hash value that does not match a sequence value stored in the hash table in association with the current data chunk.

7. The method of claim 1, wherein the positional relationship of the second data chunk to the first data chunk within the data stream or data file is contiguous.

8. A method of generating a data structure during storing data in a deduplicated format, comprising:
determining, by a processor of a computing device, a first hash value for a first data chunk of a data stream or data file;
determining, by the processor, whether the determined first hash value is located within a hash table stored in a memory of the computing device; and
in response to determining that the determined first hash value is not located within the hash table stored in the memory of the computing device:
storing in the hash table the determined first hash value and a pointer to a location in a memory of the first data chunk in association;
determining, by the processor, a second hash value for a second data chunk having a positional relationship to the first data chunk within the data stream or data file; and
storing the determined second hash value in the hash table as a first data chunk sequence value associated with the first hash value.

9. The method of claim 8, further comprising assigning data delineated by one or more data markers within the data stream or data file as a data chunk.

10. A method of encoding a data stream or data file, comprising:
determining, by a processor of a computing device, a first hash value for a first data chunk of a data stream or data file;
encoding the first data chunk in an encoded sequence as the determined first hash value;
determining, by the processor, a second hash value for a second data chunk having a positional relationship to the first data chunk within the data stream or data file;
determining, by the processor, whether the determined second hash value matches a first data chunk sequence value stored in a hash table in a memory of the computing device;
encoding, by the processor, the second data chunk in the encoded sequence as a true indicator in response to determining that the determined second hash value matches the first data chunk sequence value; and
in response to determining that the determined second hash value does not match the first data chunk sequence value:
inserting, by the processor, a false indicator at a current location in the encoded sequence; and
encoding, by the processor, the second data chunk in the encoded sequence as the determined second hash value.

11. The method of claim 10, further comprising assigning, by the processor, data delineated by one or more data markers within the data stream or data file as a data chunk.

12. The method of claim 11, wherein assigning the data delineated by the one or more data markers within the data stream or data file as a data chunk comprises assigning, by the processor, the data delineated by the one or more data markers and at least one data marker as a data chunk.

13. The method of claim 10, wherein the true indicator is a numeral indicating an offset of a current data chunk from a next data chunk that has a determined hash value that does not match a sequence value stored in the hash table in association with the current data chunk.

14. A method of decoding a data stream, comprising:
retrieving, by a processor from a hash table stored in a memory of a computing device, a first pointer to a memory location storing a first data chunk associated with a first hash value within an encoded sequence representing an original data stream or data file;
retrieving, by the processor, the first data chunk from the memory location indicated by the first pointer;
adding, by the processor, the first data chunk to a decoded data stream or data file;
determining, by the processor, whether a next encoded value in the encoded sequence is a false indicator; and
in response to determining that the next encoded value is not a false indicator:
retrieving, by the processor from the hash table, a first data chunk sequence value;
retrieving, from the hash table, a second pointer to a memory location storing a second data chunk associated with a second hash value that matches the first data chunk sequence value;
retrieving, by the processor, the second data chunk from the memory location of the indicated by the second pointer; and
adding, by the processor, the second data chunk to the decoded data stream or data file.

15. The method of claim 14, further comprising in response to determining that the next encoded value is a false indicator:
retrieving, by the processor from the hash table, a third pointer to a memory location storing a third data chunk associated with a third hash value within the encoded sequence;
retrieving, by the processor, the third data chunk from the memory location indicated by the third pointer; and
adding, by the processor, the third data chunk to the decoded data stream or data file.

16. A computing device, comprising:
a memory; and
a processor coupled to the memory and configured with processor-executable instructions to:
determine a first hash value for a first data chunk of a data stream or data file;
encode the first data chunk as the determined first hash value;
determine whether the determined first hash value is located within a hash table stored in the memory; and
in response to determining that the determined first hash value is located within the hash table stored in the memory:
determine a second hash value for a second data chunk having a positional relationship to the first data chunk within the data stream or data file;
determine whether the determined second hash value matches a first data chunk sequence value stored in the hash table in association with the first hash value; and
encode the second data chunk in an encoded sequence as a true indicator in response to determining that the determined second hash value matches the first data chunk sequence value.

17. The computing device of claim 16, wherein the processor is further configured with processor-executable instructions to assign data delineated by one or more data markers within the data stream or data file as a data chunk.

18. The computing device of claim 17, wherein the processor is further configured with processor-executable instructions to assign the data delineated by the one or more data markers within the data stream or data file as a data chunk by assigning the data delineated by the one or more data markers and at least one data marker as a data chunk.

19. The computing device of claim 16, wherein the processor is further configured with processor-executable instructions in response to determining that the determined first hash value is not located within the hash table stored in the memory to:
store the determined first hash value and a pointer to a location in memory of the first data chunk in association, in the hash table;
determine a second hash value for a second data chunk having a positional relationship to the first data chunk within the data stream or data file; and
store the determined second hash value in the hash table as a first data chunk sequence value associated with the first hash value.

20. The computing device of claim 16, wherein the processor is further configured with processor-executable instructions in response to determining that the determined second hash value does not match the first data chunk sequence value to:
insert a false indicator at a current location in the encoded sequence; and
encode the second data chunk in the encoded sequence as the determined second hash value.

21. The computing device of claim 16, wherein the processor is further configured with processor-executable instructions such that the true indicator is a numeral indicating an offset of a current data chunk from a next data chunk that has a determined hash value that does not match a sequence value stored in the hash table in association with the current data chunk.

22. The computing device of claim 16, wherein the processor is further configured with processor-executable instructions such that the positional relationship of the second data chunk to the first data chunk within the data stream or data file is contiguous.

23. A computing device, comprising:
a memory; and
a processor coupled to the memory and configured with processor-executable instructions to:
determine a first hash value for a first data chunk of a data stream or data file;
determine whether the determined first hash value is located within a hash table stored in a memory; and
in response to determining that the determined first hash value is not located within the hash table stored in the memory:
store in the hash table, the determined first hash value and a pointer to a location in memory of the first data chunk in association;
determine a second hash value for a second data chunk having a positional relationship to the first data chunk within the data stream or data file; and
store the determined second hash value in hash table as a sequence value for the first data chunk.

24. The computing device of claim 23, wherein the processor is further configured with processor-executable instructions to assigning data delineated by one or more data markers within the data stream or data file as a data chunk.

25. A computing device, comprising:
a memory; and
a processor coupled to the memory and configured with processor-executable instructions to:
determine a first hash value for a first data chunk of a data stream or data file;
encode the first data chunk in an encoded sequence as the determined first hash value;
determine a second hash value for a second data chunk having a positional relationship to the first data chunk within the data stream or data file;
determine whether the determined second hash value matches a first data chunk sequence value stored in a hash table in the memory;
encode the second data chunk in the encoded sequence as a true indicator in response to determining that the determined second hash value matches the first data chunk sequence value; and
in response to determining that the determined second hash value does not match the first data chunk sequence value:
insert a false indicator in a current location in the encoded sequence; and
encode the second data chunk in the encoded sequence as the determined second hash value.

26. The computing device of claim 25, wherein the processor is further configured with processor-executable instructions to assign data delineated by one or more data markers within the data stream or data file as a data chunk.

27. The computing device of claim 26, wherein the processor is configured with processor-executable instructions to assign the data delineated by the one or more data markers within the data stream or data file as the data chunk by assigning the data delineated by the one or more data markers and at least one data marker as a data chunk.

28. The computing device of claim 25, wherein the processor is configured with processor-executable instructions such that the true indicator is a numeral indicating an offset of a current data chunk from a next data chunk that has a determined hash value that does not match a sequence value stored in the hash table in association with the current data chunk.

29. A computing device, comprising:
a memory;
a processor coupled to the memory and configured with processor-executable instructions to:
retrieve, from a hash table stored in the memory, a first pointer to a memory location storing a first data chunk associated with a first hash value within an encoded sequence representing an original data stream or data file;
retrieve the first data chunk from the memory location indicated by the first pointer;
add the first data chunk to a decoded data stream or data file;
determine whether a next encoded value in the encoded sequence is a false indicator; and
in response to determining that the next encoded value is not a false indicator:
retrieve, from the hash table, a first data chunk sequence value;
retrieve, from the hash table, a second pointer to a memory location storing a second data chunk associated with a second hash value that matches the first data chunk sequence value;
retrieve the second data chunk from the memory location of the indicated by the second pointer; and
add the second data chunk to the decoded data stream or data file.

30. The computing device of claim 29, wherein the processor is further configured with processor-executable instructions in response to determining that the next encoded value is a false indicator to:
retrieve, from the hash table, a third pointer to a memory location storing a third data chunk associated with a third hash value within the encoded sequence;
retrieve the third data chunk from the memory location indicated by the third pointer; and
add the third data chunk to the decoded data stream or data file.

31. A computing device, comprising:
means for determining a first hash value for a first data chunk of a data stream or data file;
means for encoding the first data chunk as the determined first hash value;
means for determining whether the determined first hash value is located within a hash table stored in a memory of the computing device; and
means for performing operations in response to determining that the determined first hash value is located within the hash table stored in the memory comprising:
determining a second hash value for a second data chunk having a positional relationship to the first data chunk within the data stream or data file;
determining whether the determined second hash value matches a first data chunk sequence value stored in the hash table in association with the first hash value; and
encoding the second data chunk in an encoded sequence as a true indicator in response to determining that the determined second hash value matches the first data chunk sequence value.

32. The computing device of claim 31, further comprising means for assigning data delineated by one or more data markers within the data stream or data file as a data chunk.

33. The computing device of claim 32, wherein means for assigning the data delineated by the one or more data markers within the data stream or data file as a data chunk comprises means for assigning the data delineated by the one or more data markers and at least one data marker as a data chunk.

34. The computing device of claim 31, further comprising means for performing operations in response to determining that the determined first hash value is not located within the hash table stored in the memory comprising:
storing the determined first hash value and a pointer to a location in memory of the first data chunk in association, in the hash table;
determining a second hash value for a second data chunk having a positional relationship to the first data chunk within the data stream or data file; and
storing the determined second hash value in the hash table as a first data chunk sequence value associated with the first hash value.

35. The computing device of claim 31, further comprising means for performing operations in response to determining that the determined second hash value does not match the first data chunk sequence value comprising:
inserting a false indicator at a current location in the encoded sequence; and
encoding the second data chunk in the encoded sequence as the determined second hash value.

36. The computing device of claim 31, wherein the true indicator is a numeral indicating an offset of a current data chunk from a next data chunk that has a determined hash value that does not match a sequence value stored in the hash table in association with the current data chunk.

37. The computing device of claim 31, wherein the positional relationship of the second data chunk to the first data chunk within the data stream or data file is contiguous.

38. A computing device, comprising:
means for determining a first hash value for a first data chunk of a data stream or data file;
means for determining whether the determined first hash value is located within a hash table stored in a memory of the computing device; and
means for performing operations in response to determining that the determined first hash value is not located within the hash table stored in the memory comprising:
storing in the hash table, the determined first hash value and a pointer to a location in memory of the first data chunk in association;
determining a second hash value for a second data chunk having a positional relationship to the first data chunk within the data stream or data file; and
storing the determined second hash value in the hash table as a first data chunk sequence value associated with the first hash value.

39. The computing device of claim 38, further comprising means for assigning data delineated by one or more data markers within the data stream or data file as a data chunk.

40. A computing device, comprising:
means for determining a first hash value for a first data chunk of a data stream or data file;
means for encoding the first data chunk in an encoded sequence as the determined first hash value;
means for determining a second hash value for a second data chunk having a positional relationship to the first data chunk within the data stream or data file;
means for determining whether the determined second hash value matches a first data chunk sequence value stored in a hash table in a memory of the computing device;
means for encoding the second data chunk in the encoded sequence as a true indicator in response to determining that the determined second hash value matches the first data chunk sequence value; and
means for performing operations in response to determining that the determined second hash value does not match the first data chunk sequence value comprising:
inserting a false indicator in a current location in the encoded sequence; and
encoding the second data chunk in the encoded sequence as the determined second hash value.

41. The computing device of claim 40, further comprising means for assigning data delineated by one or more data markers within the data stream or data file as a data chunk.

42. The computing device of claim 41, wherein means for assigning the data delineated by the one or more data markers within the data stream or data file as a data chunk comprises means for assigning the data delineated by the one or more data markers and at least one data marker as a data chunk.

43. The computing device of claim 40, wherein the true indicator is a numeral indicating an offset of a current data chunk from a next data chunk that has a determined hash value that does not match a sequence value stored in the hash table in association with the current data chunk.

44. A computing device, comprising:
means for retrieving, from a hash table stored in a memory of the computing device, a first pointer to a memory location storing a first data chunk associated with a first hash value within an encoded sequence representing an original data stream or data file;
means for retrieving the first data chunk from the memory location indicated by the first pointer;
means for adding the first data chunk to a decoded data stream or data file;
means for determining whether a next encoded value in the encoded sequence is a false indicator; and
means for performing operations in response to determining that the next encoded value is not a false indicator comprising:
retrieving, from the hash table, a first data chunk sequence value;
retrieving, from the hash table, a second pointer to a memory location storing a second data chunk associated with a second hash value that matches the first data chunk sequence value;
retrieving the second data chunk from the memory location of the indicated by the second pointer; and
adding the second data chunk to the decoded data stream or data file.

45. The computing device of claim 44, further comprising means for performing operations in response to determining that the next encoded value is a false indicator comprising:
retrieving, from the hash table, a third pointer to a memory location storing a third data chunk associated with a third hash value within the encoded sequence;
retrieving the third data chunk from the memory location indicated by the third pointer; and
adding the third data chunk to the decoded data stream or data file.

46. A non-transitory processor readable media having stored thereon processor-executable instructions configured to cause a processor to perform operations comprising:
determining a first hash value for a first data chunk of a data stream or data file;
encoding the first data chunk as the determined first hash value;
determining whether the determined first hash value is located within a hash table; and
in response to determining that the determined first hash value is located within the hash table:
determining a second hash value for a second data chunk having a positional relationship to the first data chunk within the data stream or data file;
determining whether the determined second hash value matches a first data chunk sequence value stored in the hash table in association with the first hash value; and
encoding the second data chunk in an encoded sequence as a true indicator in response to determining that the determined second hash value matches the first data chunk sequence value.

47. The non-transitory processor readable media of claim 46, wherein the stored processor-executable instructions are configured to cause a processor to perform operations comprising assigning data delineated by one or more data markers within the data stream or data file as a data chunk.

48. The non-transitory processor readable media of claim 47, wherein the stored processor-executable instructions are configured to cause a processor to perform operations such assigning the data delineated by the one or more data markers within the data stream or data file as a data chunk comprises assigning the data delineated by the one or more data markers and at least one data marker as a data chunk.

49. The non-transitory processor readable media of claim 46, wherein the stored processor-executable instructions are configured to cause a processor to perform operations in response to determining that the determined first hash value is not located within the hash table comprising:
storing the determined first hash value and a pointer to a location in memory of the first data chunk in association, in the hash table;
determining a second hash value for a second data chunk having a positional relationship to the first data chunk within the data stream or data file; and
storing the determined second hash value in the hash table as a first data chunk sequence value associated with the first hash value.

50. The non-transitory processor readable media of claim 46, wherein the stored processor-executable instructions are configured to cause a processor to perform operations in response to determining that the determined second hash value does not match the first data chunk sequence value comprising:
inserting a false indicator at a current location in the encoded sequence; and
encoding the second data chunk in the encoded sequence as the determined second hash value.

51. The non-transitory processor readable media of claim 46, wherein the stored processor-executable instructions are configured to cause a processor to perform operations such that the true indicator is a numeral indicating an offset of a current data chunk from a next data chunk that has a determined hash value that does not match a sequence value stored in the hash table in association with the current data chunk.

52. The non-transitory processor readable media of claim 46, wherein the stored processor-executable instructions are configured to cause a processor to perform operations such that the positional relationship of the second data chunk to the first data chunk within the data stream or data file is contiguous.

53. A non-transitory processor readable media having stored thereon processor-executable instructions configured to cause a processor to perform operations comprising:
determining a first hash value for a first data chunk of a data stream or data file;
determining whether the determined first hash value is located within a hash table stored; and
in response to determining that the determined first hash value is not located within the hash table:
storing in the hash table, the determined first hash value and a pointer to a location in memory of the first data chunk in association;
determining a second hash value for a second data chunk having a positional relationship to the first data chunk within the data stream or data file; and
storing the determined second hash value in the hash table as a first data chunk sequence value associated with the first hash value.

54. The non-transitory processor readable media of claim 53, wherein the stored processor-executable instructions are configured to cause a processor to perform operations further comprising assigning data delineated by one or more data markers within the data stream or data file as a data chunk.

55. A non-transitory processor readable media having stored thereon processor-executable instructions configured to cause a processor to perform operations comprising:
determining a first hash value for a first data chunk of a data stream or data file;
encoding the first data chunk in an encoded sequence as the determined first hash value;
determining a second hash value for a second data chunk having a positional relationship to the first data chunk within the data stream or data file;
determining whether the determined second hash value matches a first data chunk sequence value stored in a hash table;
encoding the second data chunk in the encoded sequence as a true indicator in response to determining that the determined second hash value matches the first data chunk sequence value; and
in response to determining that the determined second hash value does not match the first data chunk sequence value:
inserting a false indicator in a current location in the encoded sequence; and
encoding the second data chunk in the encoded sequence as the determined second hash value.

56. The non-transitory processor readable media of claim 55, wherein the stored processor-executable instructions are configured to cause a processor to perform operations further comprising assigning data delineated by one or more data markers within the data stream or data file as a data chunk.

57. The non-transitory processor readable media of claim 56, wherein the stored processor-executable instructions are configured to cause a processor to perform operations such that assigning the data delineated by the one or more data markers within the data stream or data file as a data chunk comprises assigning the data delineated by the one or more data markers and at least one data marker as a data chunk.

58. The non-transitory processor readable media of claim 55, wherein the stored processor-executable instructions are configured to cause a processor to perform operations such that the true indicator is a numeral indicating an offset of a current data chunk from a next data chunk that has a determined hash value that does not match a sequence value stored in the hash table in association with the current data chunk.

59. A non-transitory processor readable media having stored thereon processor-executable instructions configured to cause a processor to perform operations comprising:
retrieving, from a hash table, a first pointer to a memory location storing a first data chunk associated with a first hash value within an encoded sequence representing an original data stream or data file;
retrieving the first data chunk from the memory location indicated by the first pointer;
adding the first data chunk to a decoded data stream or data file;
determining whether a next encoded value in the encoded sequence is a false indicator; and
in response to determining that the next encoded value is not a false indicator:
retrieving, from the hash table, a first data chunk sequence value;
retrieving, from the hash table, a second pointer to a memory location storing a second data chunk associated with a second hash value that matches the first data chunk sequence value;
retrieving the second data chunk from the memory location of the indicated by the second pointer; and
adding the second data chunk to the decoded data stream or data file.

60. The non-transitory processor readable media of claim 59, wherein the stored processor-executable instructions are configured to cause a processor to perform operations in response to determining that the next encoded value is a false indicator comprising:
retrieving, from the hash table, a third pointer to a memory location storing a third data chunk associated with a third hash value within the encoded sequence;
retrieving the third data chunk from the memory location indicated by the third pointer; and
adding the third data chunk to the decoded data stream or data file.
